(19) United States
(12) Patent Application Publication
(10) Pub. No.: US 2026/0264086 A1
(43) Pub. Date: Sep. 10, 2026

(54) PIPETTE TIP SUPPORT CARD BUNDLES WITH ALIGNMENT GUIDE

(71) Applicant: Xcaliber Sciences, Inc., San Diego, CA (US)

(72) Inventor: Arta Motadel, San Diego, CA (US)

(21) Appl. No.: 19/350,631

(22) Filed: Oct. 6, 2025

Related U.S. Application Data
(60) Provisional application No. 63/767,308, filed on Mar. 5, 2025.

(51) Int. Cl. B01L 9/00

(52) U.S. Cl. CPC B01L 9/543; B01L 2200/025; B01L 2200/12; B01L 2300/0816; B01L 2300/12

(57) ABSTRACT

Systems and methods for assembling pipette tip support card bundles use an alignment guide with dome-shaped projections and voids to direct tip distal ends into receiver slots, preventing misalignment and static. The guide may be removable for interleaved bundles or integrated for non-interleaved ones, maintaining tip plumbness. Preferred embodiments include plastic construction, standard array compatibility, and features for reduced tip contact and improved orthogonality.

### CROSS-REFERENCE TO RELATED APPLICATIONS

This application claims priority to U.S. Provisional Patent Application 63/767,308 entitled “Alignment Guide for Pipette Tip Support Card and Methods of Use of Same” and filed on Mar. 5, 2025. The entire contents of this application are incorporated by reference in its entirety.

This application is also related to U.S. Provisional Application No. 63/614,919, filed Dec. 26, 2023, entitled “Pipette Tip Support Card Bundles”; to U.S. Provisional Application No. 63/567,766, filed Mar. 20, 2024, entitled “Pipette Tip Support Card Bundles”; to U.S. application Ser. No. 18/620,627, filed Mar. 28, 2024, entitled “Pipette Tip Support Card Bundles”; and to U.S. Pat. No. 11,701,663, issued Jul. 18, 2023. The entire contents of each of these applications and patents are incorporated.

### TECHNICAL FIELD

The present invention relates to pipette tip systems, and more particularly to support cards, racks, and alignment guides for assembling interleaved and non-interleaved pipette tip bundles and for maintaining tip alignment (true plumb) during manufacturing, storage, transport, and automated loading.

### BACKGROUND

In prior pipette tip systems, such as those disclosed in the related applications incorporated above, interleaved pipette tip cards allow compact storage and access to multiple layers of tips. However, manufacturing these interleaved bundles presents challenges. Inserting a first plurality of pipette tips into a support card such that the pipette tips' distal ends align precisely with receiver slots on an adjacent card is difficult and time-consuming, often requiring manual adjustment. Misalignment can cause tips to rub against each other, generating static electricity that attracts dust or disrupts automated pipetters from forming a proper seal. Additionally, tips may bend or lose their true plumb configuration (i.e., a straight central axis perpendicular to the support card), complicating loading. Conventional support cards typically hold only the proximal end of the tip, leaving the distal end unsupported and prone to these issues.

Conventional pipette tip racks often constrain a tip only near the proximal end, allowing the distal end to hang freely. During manufacturing and handling, adjacent tips can contact and rub, generating static charge, deviating the tips from a true plumb orientation, and making automated loading less reliable. Accurately guiding dozens to hundreds of distal ends into corresponding receivers on a mating card is time-consuming and error-prone, especially for interleaved bundles that require two cards to be populated with tips in opposed orientations.

A need exists for systems and methods that facilitate accurate assembly of pipette tip support cards, prevent tip contact during manufacturing and use, reduce static buildup, maintain tip alignment, guide distal ends into receiver slots quickly and repeatably, stabilize tips at both proximal and distal regions to maintain orthogonality, and reduce tip-to-tip rubbing and static charge generation.

### SUMMARY

The present invention provides systems and methods for assembling pipette tip support card bundles using an alignment guide to ensure precise placement of tip distal ends into receiver slots. In one embodiment, the alignment guide includes a base with a plurality of cylindrical dome-shaped projections and voids aligned with the receiver slots of a support card. When inserted into the support card, the domes guide the distal ends of pipette tips from an upper card into the slots of a lower card, preventing contact and misalignment.

In one aspect, a removable or integrated alignment guide is provided on a lower support card. The guide includes an array of upward projections separated by voids that are laterally aligned with receiver slots in the lower card. When tips are inserted into an upper support card, their distal ends contact the projections and are cammed laterally until they drop into the aligned receiver slots. The guide may be removed after a first plurality of tips is seated, and a second plurality of tips can then be inserted into the lower support card and guided by the first plurality into the receiver slots of the upper card to form an interleaved bundle.

In another aspect, the alignment features are integrated into a receiver card to stabilize distal ends during storage and shipment in non-interleaved configurations, reducing static build-up and misalignment without the need for a separate guide.

The guide may be removable for interleaved bundles or integrated for non-interleaved configurations to maintain tip plumbness. Preferred materials include injection-molded plastic (e.g., polypropylene) for durability and low static. Non-limiting example dimensions include dome radii of about 0.5-5 mm (e.g., 1-2 mm) and slot depths of about 1-10 mm (e.g., 2-5 mm), scalable for standard tip arrays (e.g., 4×6, 8×12, 16×24 or 32×48). Variations include automated insertion mechanisms and compatibility with tip volumes from 5 μL to 10 ML.

Additional aspects, alternatives and variations, as would be apparent to persons of skill in the art, are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### BRIEF DESCRIPTION OF THE DRAWINGS

The invention may be better understood by reference to the following figures, which are not necessarily to scale, with emphasis on illustrating principles. Like reference numerals designate corresponding parts. Various features from different embodiments may be combined.

FIG. 1A1 is a top plan view of an alignment guide.

FIG. 1A2 is a top isometric view of the alignment guide.

FIG. 1A3 is another top isometric view of the alignment guide.

FIG. 1B is a top isometric view of a second pipette tip support card showing the pipette tip support holes and receiver slots.

FIG. 1C1 is a top plan view of the alignment guide inserted into the second pipette tip support card.

FIG. 1C2 is a top isometric view of the alignment guide inserted into the second pipette tip support card.

FIG. 1C3 is another top isometric view of the alignment guide inserted into the second pipette tip support card.

FIG. 1D is a top isometric view of a first and a second pipette tip support card with the alignment guide positioned for insertion into the second pipette tip support card.

FIG. 2 is a top isometric view of the first and second pipette tip support cards with the alignment guide inserted into the second pipette tip support card.

FIG. 3 is a top isometric view of the assembly of FIG. 2 with a first plurality of pipette tips positioned for insertion into the first pipette tip support card.

FIG. 4 is a top isometric view showing the first plurality of pipette tips partially inserted into the first pipette tip support card.

FIG. 5A is a top isometric view showing the first plurality of pipette tips fully inserted into the first pipette tip support card, with distal ends guided into the receiver slots on the second pipette tip support card.

FIG. 5B is a cross-sectional view taken along line A-A of FIG. 5A, illustrating the guidance of the distal ends.

FIG. 6 is a top isometric view of the assembly with the alignment guide removed.

FIG. 7 is a top isometric view with a second plurality of pipette tips positioned for insertion into the second pipette tip support card.

FIG. 8 is the view of FIG. 7 rotated 180 degrees, with the second pipette tip support card on top.

FIG. 9 is a top isometric view showing the second plurality of pipette tips partially inserted into the second pipette tip support card.

FIG. 10A is a top isometric view showing the second plurality of pipette tips fully inserted, with distal ends guided into the receiver slots on the first pipette tip support card.

FIG. 10B is a cross-sectional view taken along line B-B of FIG. 10A, illustrating the guidance of the distal ends.

### DETAILED DESCRIPTION

The following description provides specific examples of the present invention, including preferred embodiments. These are illustrative and not limiting; alternatives, modifications, and equivalents within the spirit and scope are encompassed. Numerous details are set forth for thorough understanding, but embodiments may omit some. Well-known processes are not detailed to avoid obscurity. Techniques may be singular or iterative, steps not in fixed order unless noted, and connections not necessarily direct.

### DEFINITIONS

“Support card”: a plate or frame with an array of tip support holes configured to retain pipette tips by their proximal regions.

“Receiver slot”: an aperture or slot in a support card positioned to accept a distal end of a tip extending from an opposed card; receiver slots may be circular, oval, rectangular, or chamfered.

“Alignment guide”: a removable or integrated component having an array of upward alignment projections separated by voids. Each void is laterally aligned with a receiver slot to provide a lead-in for a distal end.

“Alignment projection”: a projection (e.g., dome, conical, frustoconical, or hemispherical feature) that laterally guides a distal tip end into a void/receiver slot.

“True plumb”: a pipette tip orientation with its central axis substantially perpendicular (within ±1.5° in some embodiments) to the plane of the support card.

“Proximal end” and “Distal end”: the end of the tip nearest/farthest from the pipette coupler when the tip is mounted for use.

The following list of example features corresponds with the attached figures and is provided for ease of reference, where like reference numerals designate corresponding features throughout the specification and figures:
First Pipette Tip Support Card: 5
Second Pipette Tip Support Card: 10
Pipette Tip Support Hole: 12
Receiver Slot: 14
Alignment Guide: 15
Alignment Guide Movement: 15.1
Cylindrical Dome-Shaped or Sloped Projection: 15.2
First Plurality of Pipette Tips: 20
First Plurality of Pipette Tips Movement: 20.1
Pipette Tip Alignment Guide Void: 25
Second Plurality of Pipette Tips: 30
Second Plurality of Pipette Tips Movement: 30.1

### OVERVIEW

A first support card 5 includes an M×N array of tip support holes (e.g., 4×6 for 24 format, 8×12 for 96-format, 16×24 for 384-format or 32×48 for 1536 format). A second support card 10 includes corresponding receiver slots 14. An alignment guide 15 is removably or integrally coupled to the second card 10. The alignment guide 15 may be removably coupled to the second support card by snap features, rails, or detents. The guide provides a two-dimensional array of projections that are laterally offset from the receiver slots by a small radial gap; intervening voids are co-axial with the receiver slots.

One issue with manufacturing interleaved pipette tip bundles is that inserting the first plurality of pipette tips 20 into the first pipette tip support card 5, such that each of the many distal ends falls into the receiver slots 14 on the bottom second pipette support card 10 is extremely difficult and time-consuming to achieve. Using an alignment guide 15, having a base configured for insertion into a pipette tip support card, a plurality of cylindrical dome-shaped projections 15.2 protruding from the base, and a plurality of voids 25, each void 25 aligned with a receiver slot 14 on the support card 10 when inserted, solves the problem. The base may be removable from the support card 10. Each projection 15.2 has a sloped surface configured to contact and to direct a distal end of a pipette tip towards a void 25. Each void 25 is aligned with a receiver slot 14 on the support card 10 when inserted. The voids 25 and projections 15.2 cooperate to guide pipette tip distal ends into the receiver slots without contact between adjacent tips. The dome-shaped projections 15.2 may have, as a non-limiting example, radii of about 0.5-5 mm (e.g., 1-2 mm).

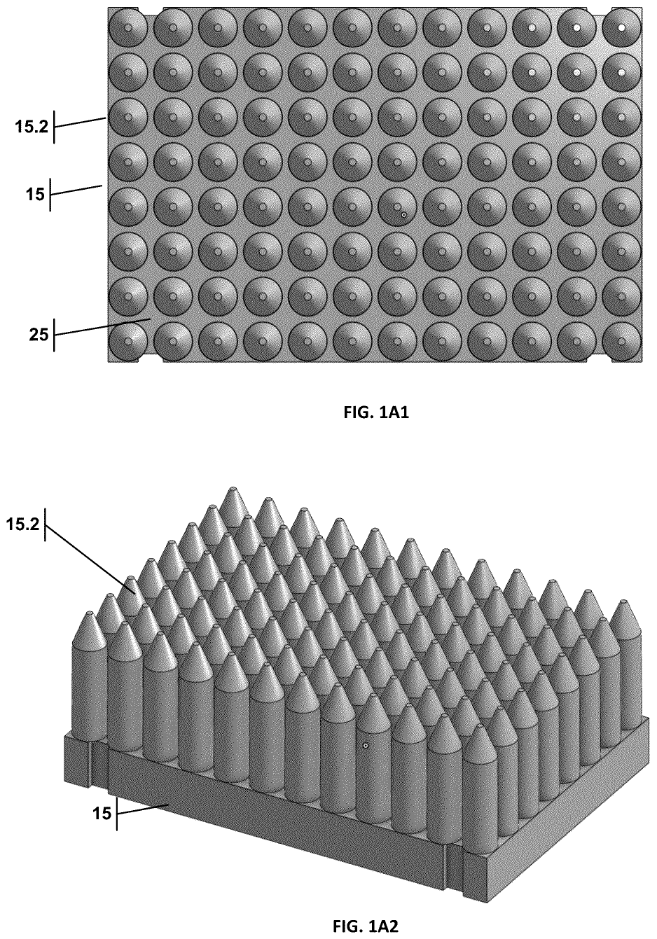

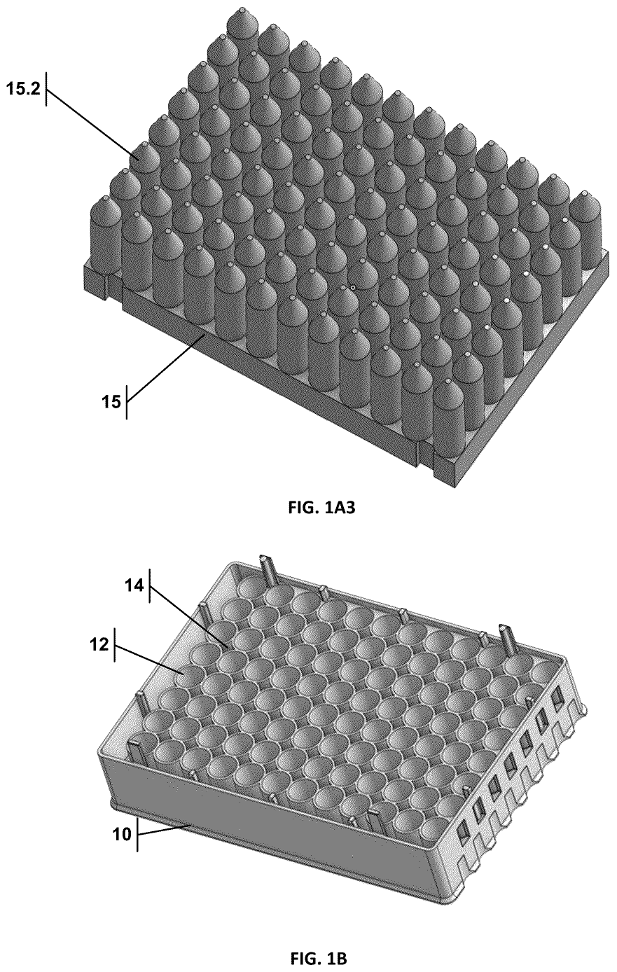

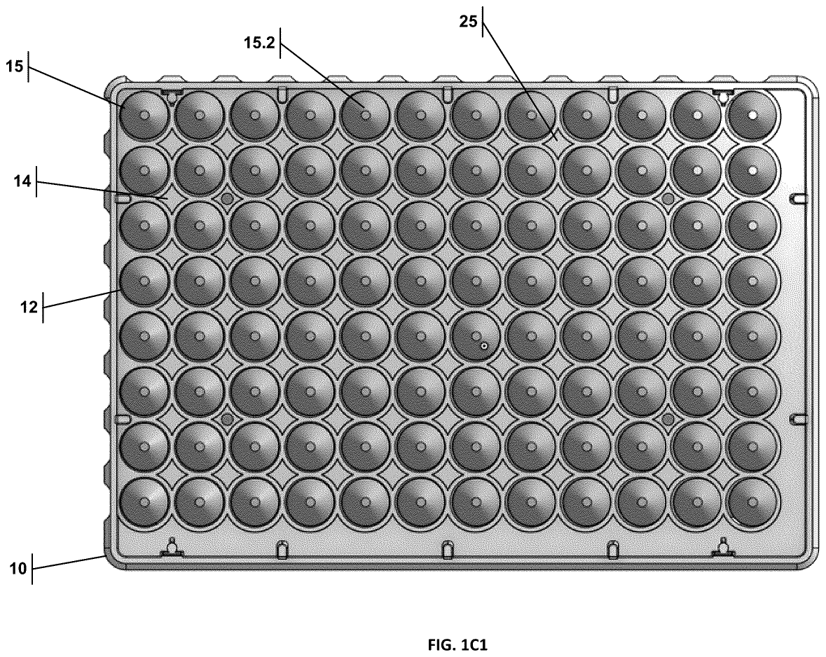

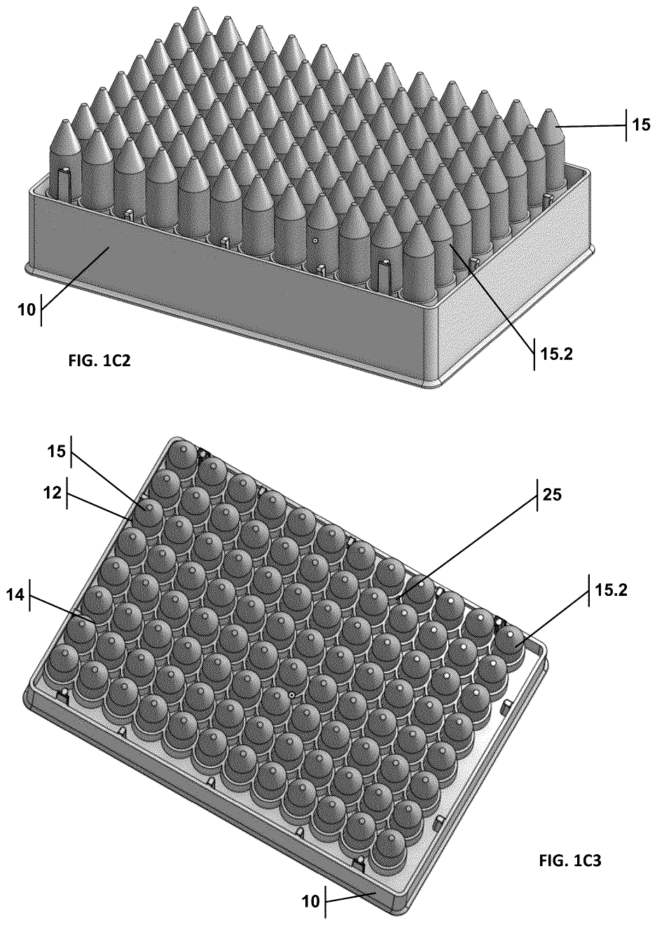

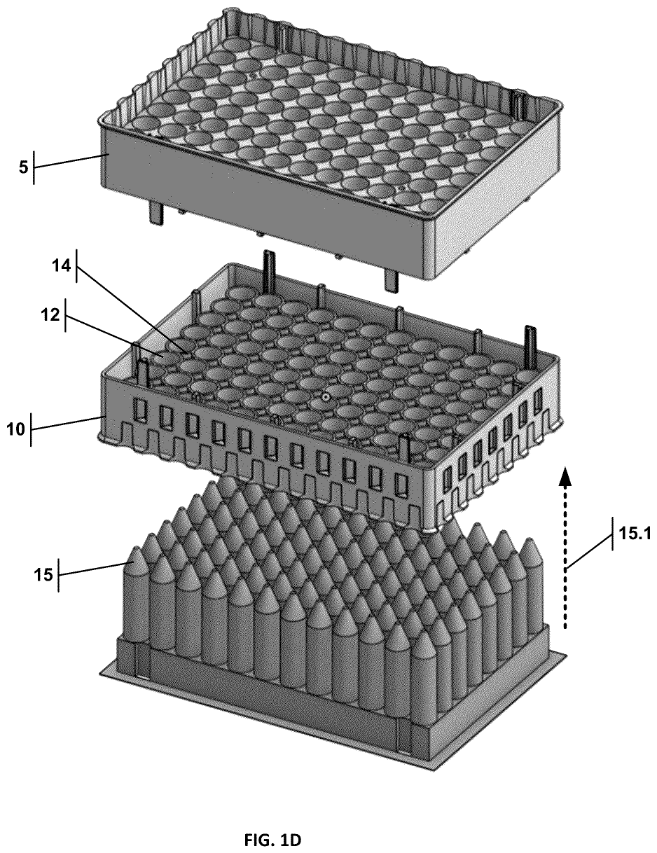

As shown in FIG. 1A1-1A3, the alignment guide 15 has multiple sets of several cylindrical dome-shaped projections 15.2 and a void 25 surrounded by the several cylindrical dome-shaped projections 15.2. When the guide 15 is inserted into the second pipette tip support card 10, as shown in FIG. 1C1-1C3, the voids 25 align with the receiver slots 14 on the second pipette tip support card. The cylindrical dome-shaped projections 15.2 may contact the distal end of the pipette tips, as those tips are inserted into the first pipette tip support card, and the distal ends of the pipette tips may then travel along the cylindrical dome-shaped projections 15.2 until the distal ends dock into the receiver slots 14 on the second pipette tip support card 10.

The pipette tip support cards, such as the second pipette tip support card 10 illustrated in FIG. 1B, typically feature a rectangular planar structure with an array of pipette tip support holes 12 and receiver slots 14 arranged in an alternating pattern. In preferred embodiments, this array follows a standard 96-position format (e.g., 8 rows by 12 columns), where the support holes 12 are circular apertures sized to securely hold the proximal ends of pipette tips, and the receiver slots 14 are elongated or rectangular openings positioned adjacent to each support hole 12 to accommodate the distal ends of interleaved tips from an adjacent card. This alternating configuration enables the interleaving of pipette tips between stacked cards, preventing contact between adjacent tips, and minimizing static electricity buildup during manufacturing, storage, or use. The cards may be constructed from rigid, low-static materials such as injection-molded polypropylene or polystyrene, with thicknesses ranging from 1-5 mm to provide structural integrity while also allowing for the ability to stack support cards in bundles.

The alignment guide 15, as depicted in FIG. 1A1-1A3, comprises a base plate with an array of protruding cylindrical dome-shaped projections 15.2, each having a sloped, curved surface (e.g., hemispherical or conical with a rounded apex) designed to gently redirect misaligned pipette tip distal ends toward the voids 25 between the cylindrical dome-shaped projections 15.2. The projections 15.2 are positioned to correspond with the support holes 12 or non-receiver areas of the support card, while the voids 25—typically circular or slotted openings in the base—align precisely with the receiver slots 14. In an example configuration, the domes have a height of 2-10 mm and a base diameter of about 2-8 mm (e.g., 3-6 mm), tapered to a radius of about 0.5-5 mm (e.g., 1-2 mm) at the top, to facilitate smooth sliding of tip ends without abrasion. The voids 25 may have diameters matching the tip distal ends, including as a non-limiting example of 1-3 mm, ensuring unobstructed passage. The guide 15 may be fabricated from antistatic plastic via injection molding or via 3D printing, with surface treatments (e.g., polished or coated) to reduce friction coefficients below 0.3 for optimal guiding performance.

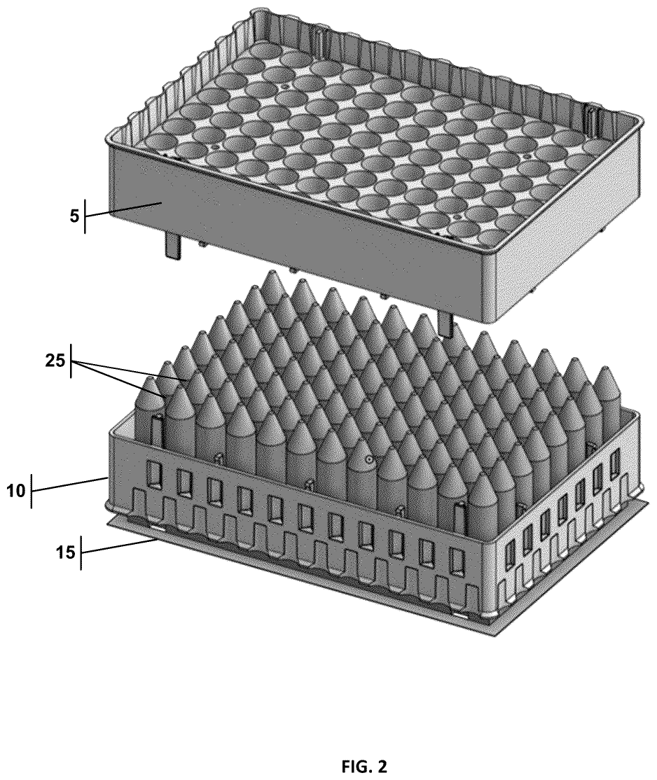

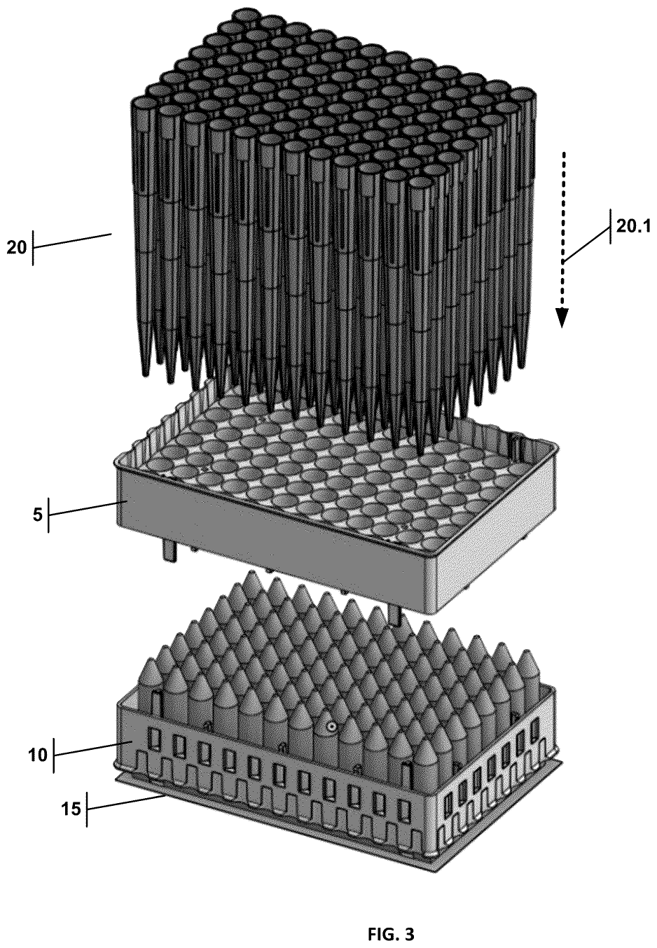

FIGS. 1D-10B illustrates structures and methods for manufacturing properly aligned pipette tips. The guide 15 is inserted into the second pipette tip support card 10 (FIGS. 1D and 2), with movement direction 15.1 indicating a sliding or snap-fit insertion mechanism between the guide 15 and the second pipette tip support card 10, potentially aided by alignment tabs or rails on the guide edges to ensure precise positioning within tolerances of ±1.0 mm. Once inserted, as shown in FIG. 2, the domes 15.2 protrude upward through or adjacent to the support holes 12, creating a guiding landscape for incoming tips. A first plurality of pipette tips 20 can then be inserted into the first pipette tip support card 5 (FIGS. 3-5A), with movement 20.1 representing downward force applied manually or via automated machinery, such as robotic arms equipped with vacuum grippers or press plates. The plurality of pipette tips 20, typically conical in shape with lengths on the order of several mm (e.g., 30-150 mm) and volumes ranging from 5 μL to 10 ML, are aligned in a jig or tray prior to insertion to match the support hole pattern. The support cards 5, 10 and the alignment guide 15 may be injection molded from polypropylene, polyethylene, ABS or combinations thereof.

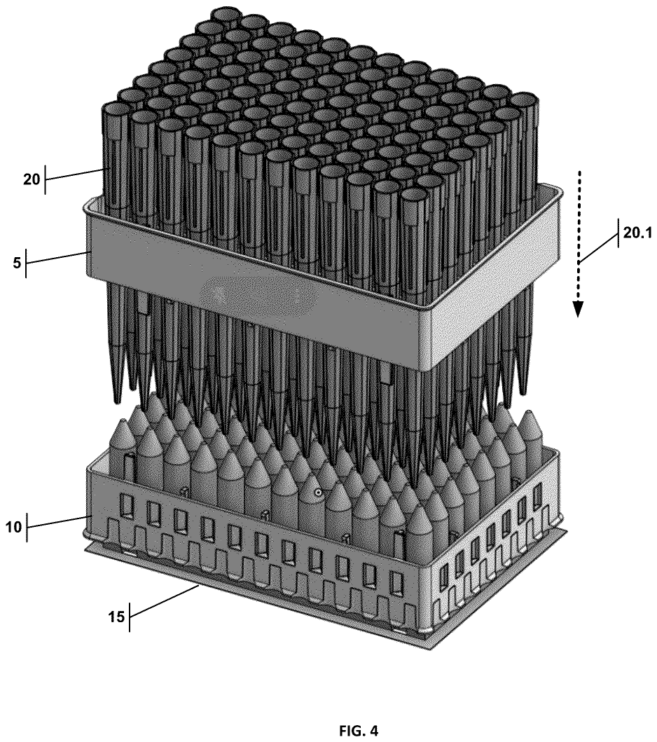

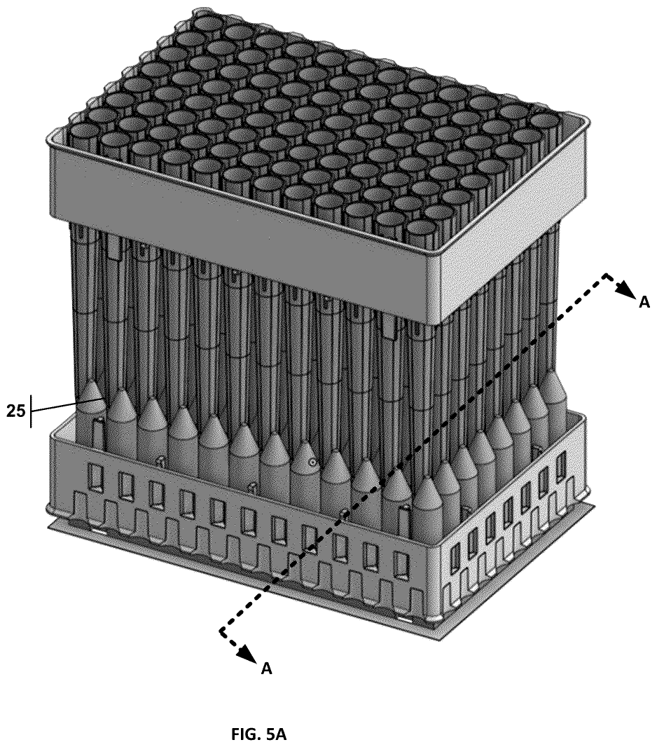

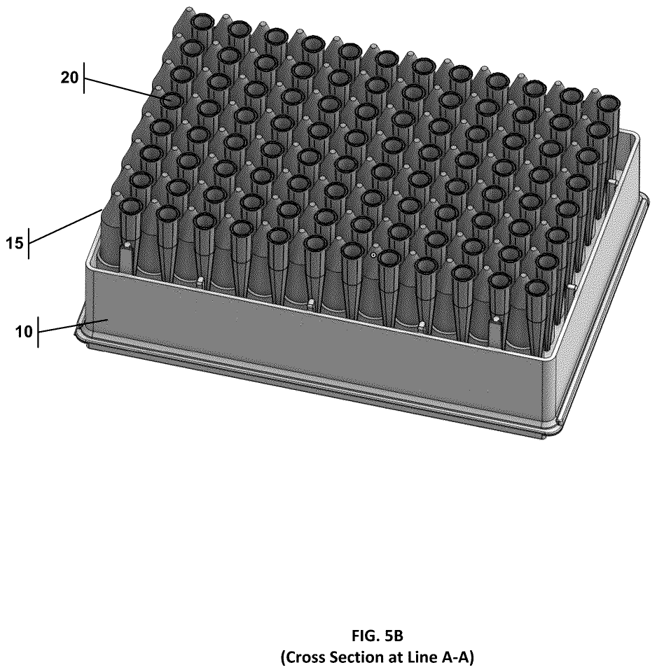

As illustrated in FIG. 4, during partial insertion, the distal ends of the tips 20 contact the sloped surfaces of the domes 15.2, which deflect and guide them laterally toward the voids 25. This self-correcting mechanism accommodates initial misalignments up to 1-9 mm, reducing assembly errors and assembly time by up to 50% compared to manual assembly methods. In FIG. 5A, full insertion is achieved, with the distal ends docked securely in the receiver slots 14 via the voids 25. The cross-sectional view in FIG. 5B, taken along line A-A, reveals how the domes 15.2 funnel the plurality of pipette tips 20 into the slots without tip-to-tip or tip-to-card contact, preserving tip integrity and preventing contamination or deformation. The receiver slots 14 may have various depths, including as a non-limiting example of 2-5 mm, and may have flared entrances to further ease docking, with optional resilient linings for shock absorption.

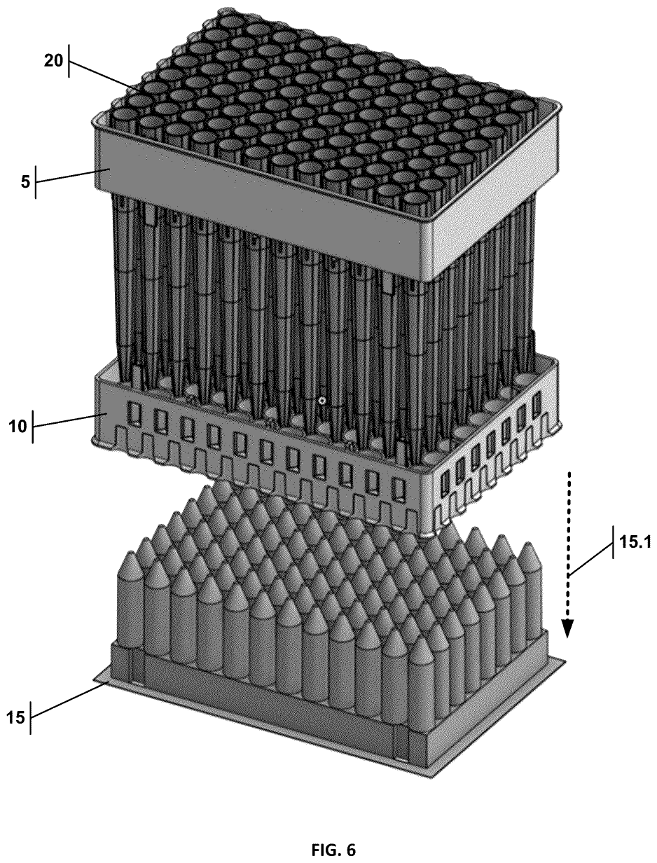

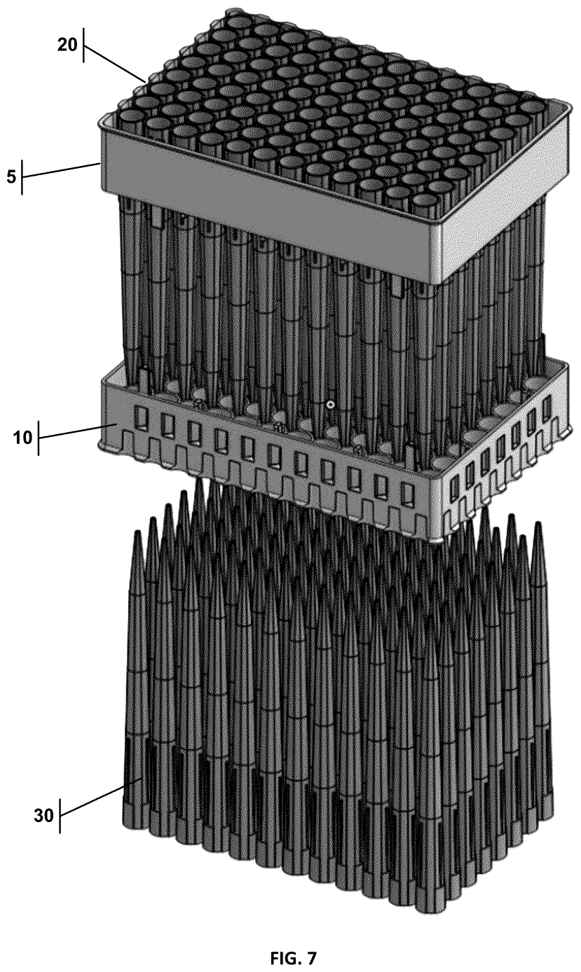

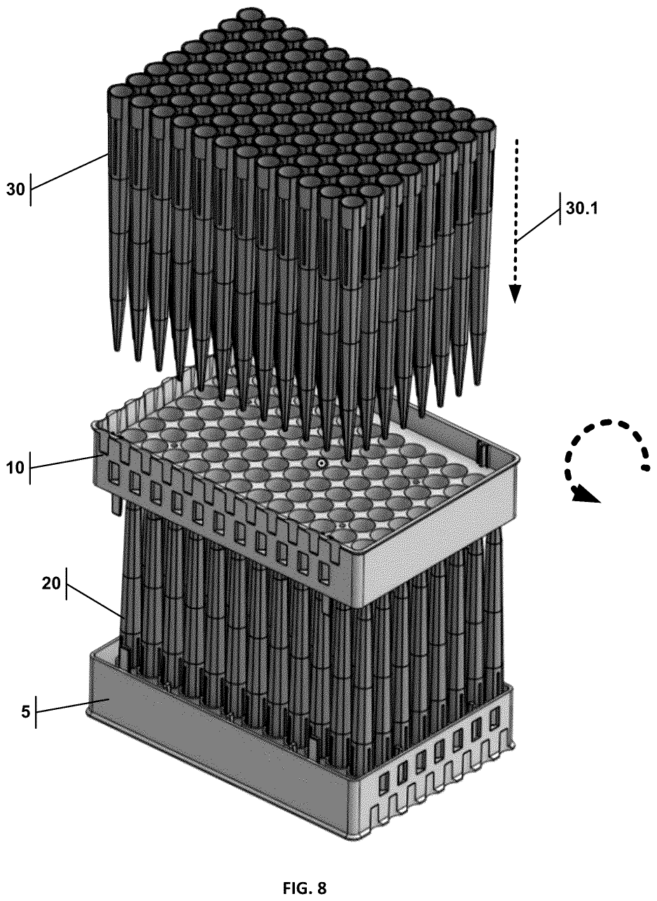

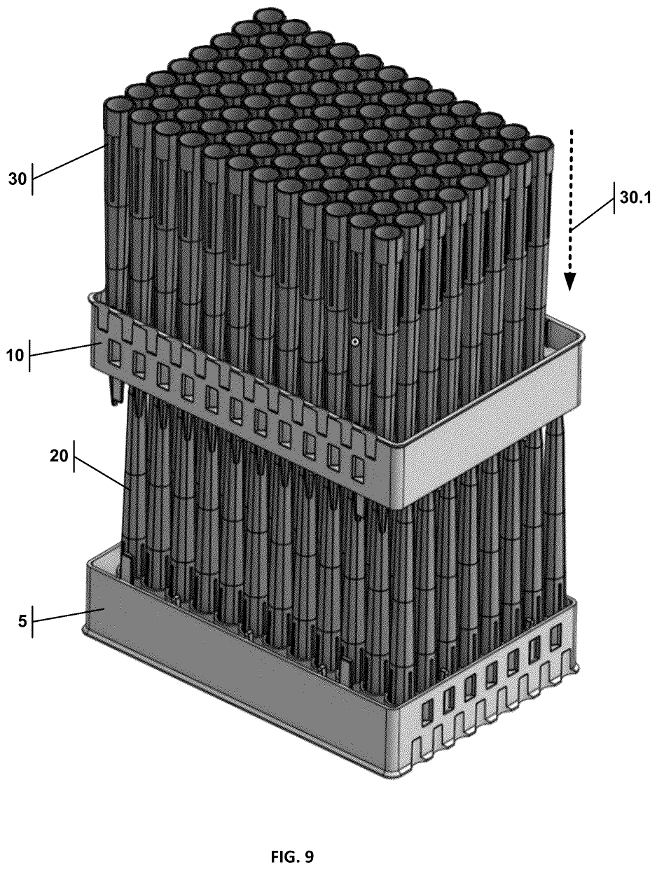

The guide 15 may be removed (FIG. 6) by reversing movement 15.1, potentially using extraction tools or integrated handles to avoid disturbing the seated tips. Following removal, a second plurality of pipette tips 30 may be inserted through the first pipette tip support card 5 into the second pipette tip support card 10, as shown in FIGS. 7-10A. FIG. 7 depicts the assembly oriented with the second card 10 on the bottom, and FIG. 8 shows a 180-degree rotation for accessibility, highlighting the bundle's versatility for multi-layer stacking. During insertion (FIG. 9), movement 30.1 directs the second plurality of pipette tips 30 downward, with their distal ends now guided by the tapered exteriors of the first plurality of tips 20, which act as natural funnels due to their conical shape. This secondary guiding leverages the already-seated tips to align the new plurality into the receiver slots 14 on the first card 5.

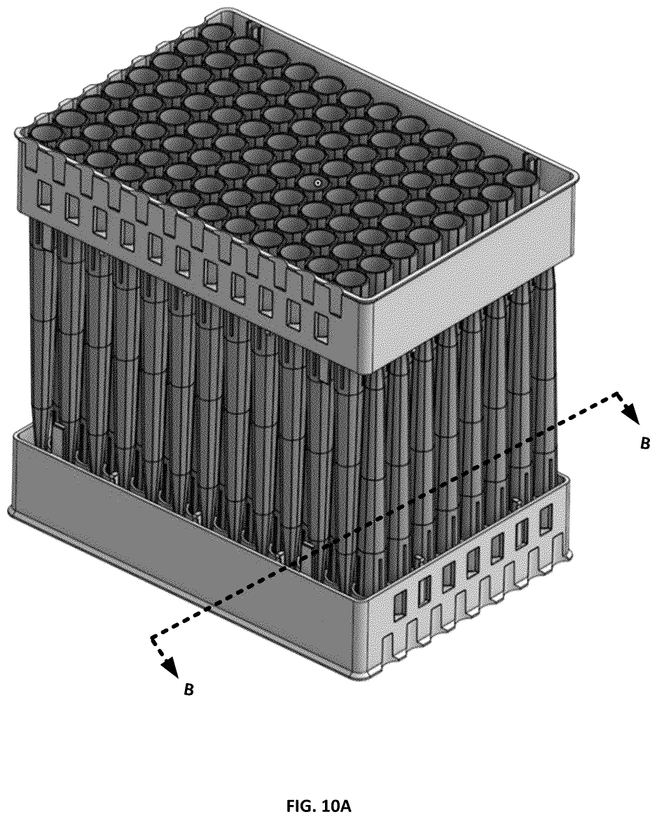

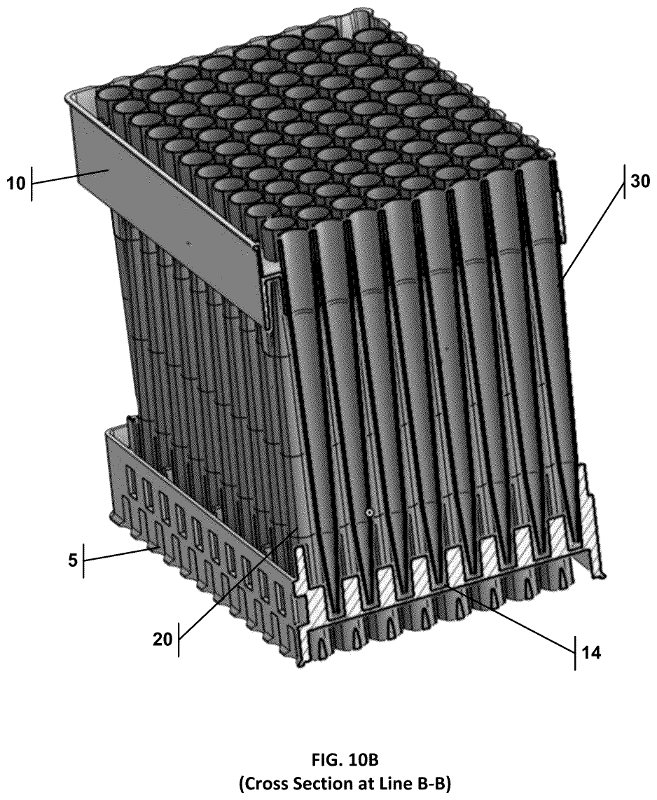

In FIG. 10A, complete insertion forms the interleaved bundle, where tips from each card alternate in position (e.g., in a checkerboard pattern), maximizing packing density while minimizing contact between the different pluralities of pipette tips. The cross-section in FIG. 10B, along line B-B, demonstrates how the distal ends of the second plurality of pipette tips 30 nest into the receiver slots 14 without rubbing against the first plurality of pipette tips 20, reducing static charge generation (typically below 100 V) and ensuring all tips 20, 30 remain true plumb-defined as having a central axis substantially perpendicular to the card surface (e.g., ±1.5°). This plumb configuration is critical for compatibility with automated pipetters, which require precise alignment for sealing and for dispensing accuracy.

While the guide 15 is shown to be removable, the guide may be integrated into the bottom card and may not be removable. This could be used in a non-interleaved pipette tip bundle and would help keep the distal end of the pipette tips aligned and straight, preventing adjacent tips from rubbing against each other. This is an advantage over the current art, where the support cards often support only the proximal end of the pipette tip, leaving the distal end to freely hang. Not only can the free hanging of pipette tip distal ends causes static electricity, but it can also misalign the tips such that an automated system may not be able to effectively load the tips. Also, the tips may become misaligned and no longer true plumb—i.e., a center axis that is straight. Indeed, during manufacturing, the tips may not be true plumb, but having the guides 15 and receiver holes 14 as described above would fix the pipette tips 20, 30 into a true plumb configuration, such that the tip will keep its true plumb configuration until the tip is removed and used. In integrated embodiments, the guide may include retention features, such as clips or adhesives, to permanently affix it to the card, providing ongoing support during shipping and storage.

The present invention thus provides a pipette tip support card system, comprising a first support card 5 and a second support card 10, the alignment guide 15 discussed above integrated into the second support card 10. The first support card 5 may have a plurality of pipette tip support holes 12 and receiver slots 14. The second support card 10 may have a plurality of pipette tip support holes 12 and receiver slots 14 as well. When assembled, the guide 15 maintains pipette tips in a true plumb configuration. In another aspect, the present invention also provides a novel pipette tip rack, comprising a support card 10 having an array of tip support holes 12 and an integrated alignment structure disposed below the support card 10 and comprising a two-dimensional array of projections 15.2 forming intervening voids 25 aligned with receiver slots on the support card 10, wherein the integrated alignment structure supports and constrains distal ends of tips seated in the tip support holes 12 to maintain a true plumb orientation. The integrated alignment structure of the pipette tip rack reduces tip-to-tip lateral contact relative to an otherwise identical rack lacking the integrated alignment structure.

Additional variations may include scalable high-density array sizes (e.g., 384-position or 1536-positions for high-throughput applications), adjustable dome geometries (e.g., steeper slopes for narrower tips), or automated quality control integration, such as optical sensors to verify tip docking. Materials for tips may include virgin polypropylene for sterility, with optional filters or low-retention coatings. The bundle may incorporate stacking offsets or aprons, as in related applications, to facilitate multi-card assemblies (e.g., four or six cards) while maintaining interleaving.

### OPERATION

As pipette tips are inserted, their distal ends initially contact the sidewalls of the alignment projections 15.2 and slide along a cam surface, guiding them smoothly. As the insertion process continues, each distal end is directed laterally toward a void 25 in the guide, allowing it to drop through the void 25 and into a corresponding receiver slot 14. This engagement securely captures the distal end, restricting tip yaw and roll to preserve a true plumb orientation.

For an interleaved assembly, once the first plurality of tips is fully seated and the guide is removed, the partially populated bundle can be flipped or rotated. This adjustment enables the insertion of a second plurality of tips 30 into the second support card 10, with their distal ends guided by the first plurality of pipette tips 20 into the receiver slots of the first card, resulting in a completed interleaved assembly featuring opposing tip orientations.

In the case of non-interleaved racks, the integrated-guide version can be employed within single-card racks. This configuration supports the distal ends during storage and shipping, effectively reducing tip rub and maintaining alignment to ensure compatibility with automated loaders.

### MANUFACTURE

Support cards and guides can be fabricated via injection molding (e.g., polypropylene, polyethylene, ABS, HIPS), thermoforming, or additive manufacturing. Projections can be hemispherical, ogival, conical, or frustoconical to present a smooth lead-in. Receiver slots can be circular, elliptical, chamfered, or funnel-shaped to provide additional lead-in. Features can be molded with draft to ease ejection and to reduce wear during repeated insertions of guides.

### GEOMETRY

For a 24-format card, center-to-center spacing is typically 18 mm; for a 96-format card, center-to-center spacing is typically about 9.0 mm; for a 384-format card, center-to-center spacing is typically about 4.5 mm; and for other format cards, the corresponding center-to-center spacing that is typical. Projection height can vary; some non-limiting examples include between 3-15 mm (e.g., 5-10 mm), with tip-contact surfaces having a radius of about 0.5-10 mm (e.g., 1-5 mm). Voids are sized to be larger than the maximum distal tip diameter by 0.1-1.0 mm to prevent scraping, while receiver slots provide an additional clearance of about 0.05-1.0 mm. Tolerances can be asymmetric to bias tips toward the void centers. In other words, a clearance between a distal tip diameter and a corresponding void 25 may varyl some non-limiting examples include between 0.1 mm and 1.0 mm. Also, each void 25 is coaxial with a corresponding receiver 14 slot within ±1.0 mm. The alignment projections 15.2 may have different heights; some non-limiting examples include between 3 mm and 15 mm. These values are exemplary and can be adjusted for tip geometry.

### ANTI-STATIC STRATEGIES

Materials may include antistatic additives, conductive fillers, or surface treatments (e.g., corona, antistatic coatings). Grounding features, conductive traces, or metallic inserts may be used to bleed charge from captured distal ends. The second support card 10 may include antistatic material or conductive pathways to dissipate charge from captured distal ends of pipette tips. The alignment guide 15 prevents static electricity buildup by avoiding tip-to-tip contact.

### INTEGRATION OPTIONS

In some embodiments, the guide 15 and the integrated alignment structure thereof is monolithic with the second support card 10; in other embodiments, it is a removable insert keyed by tabs, rails, or snap latches. Detents or interference fits may temporarily couple the guide to the card during the first insertion cycle and allow tool-less removal thereafter. In the pipette tip rack made in accordance with the present invention, the integrated alignment structure reduces tip-to-tip lateral contact relative to an otherwise identical rack lacking the integrated alignment structure.

### EXAMPLE MANUFACTURING & ASSEMBLY METHODS

Begin by positioning the alignment guide 15 on or within the second support card 10, ensuring that the voids 25 are precisely coaxial with the corresponding receiver slots. Next, align the first support card 5 above the second support card 10 at a fixed separation distance, maintaining parallel planes between them. Then, insert a first plurality of pipette tips 20 through the first support card 5, allowing their distal ends to contact the alignment projections 15.2 on the alignment guide 15 and to be cam-guided into the receiver slots 14 of the second support card 10. After this step, remove the alignment guide 15, leaving the distal ends securely captured within the receiver slots. As needed, rotate the assembly and insert a second plurality of tips 30 into the second support card, guiding their distal ends with the first plurality into the receiver slots of the first support card. Optionally, enhance sterility and positional stability during shipment by installing lids, seals, or covers. The method of assembling a pipette tip support card bundle comprises: a) providing a first support card 5 and a second support card 10, each having pipette tip support holes 12 and receiver slots 14; b) inserting an alignment guide 15 into the second support card 10, the guide 15 having dome-shaped projections 15.2 and voids 25 aligned with the receiver slots 14; c) inserting a first plurality of pipette tips 20 into the support holes of the first support card 5, wherein distal ends of the first plurality 20 are guided by the dome-shaped projections 15.2 into the receiver slots 14 on the second support card; d) removing the alignment guide 15; and e) inserting a second plurality of pipette tips 30 into the support holes 12 of the second support card 10, wherein distal ends of the second plurality 30 are guided by the first plurality 20 into the receiver slots 14 on the first support card 5. The inserting steps of this method could be performed automatically using a robotic system. The method may further comprise stacking additional support cards to form a multi-layer interleaved bundle. The method may further comprise rotating or inverting the partially assembled bundle between the steps of c) inserting the first plurality of pipette tips 20 and the second plurality of pipette tips 30. The method may further comprise applying an antistatic coating to at least one of the support cards 5, 10 or the alignment guide 15. In conjunction with this method, the receiver slots 14 and tip support holes 12 may conform to a 24-format pitch, a 96-format pitch, a 384-format pitch or 1536-format pitch and the alignment guide 15 may be keyed to the second support card 10 to enforce a single orientation.

### ADVANTAGES

The alignment guide system offers several key advantages, including faster population of dense tip arrays with fewer misfeeds, reduced tip-to-tip contact and static charge accumulation, improved orthogonality (true plumb) of tips to enhance compatibility with automated loading, compatibility with standard 24/96/384/1536 pitches and SBS/SLAS footprints, and the flexibility of a field-replaceable guide option or integrated structures for disposable racks. The pitch of the tip support holes and the receiver is about 18 mm (24-format), 9.0 mm (96-format), 4.5 mm (384-format), and 2.25 mm (1536-format).

### EXAMPLES

Example 1 (96-format). A pair of polypropylene support cards is molded with a 9.00 mm pitch. A removable polypropylene guide is molded with 7.0 mm tall hemispherical projections, 3.0 mm radius tip-contact surfaces, and void diameters 0.3 mm larger than a maximum distal tip diameter. First tips are inserted through the upper card and guided into lower receiver slots. The guide is removed, the assembly is inverted, and a second plurality of tips is inserted to form an interleaved bundle.
Example 2(384-format with antistatic). The lower card is molded from ABS compounded with 10-15% carbon-loaded fibers to afford surface resistivity below 10\hat{ }8 Ω/sq. Slots are chamfered at 30°. The integrated alignment structure maintains tip substantially perpendicular (e.g., ±1-5°).

### VARIATIONS

The features disclosed herein can be combined in any operable arrangement unless a specific incompatibility is noted. Dimensions and ranges are exemplary; all values include tolerances appropriate for the manufacturing process. Terms used in the claims should be construed as having their plain and ordinary meaning to a person of ordinary skill in the art unless explicitly defined herein.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter that is broadly contemplated by the present invention. It is further understood that the scope of the present invention fully encompasses other embodiments that may become obvious to those skilled in the art, and that the scope of the present invention is accordingly limited by nothing other than the appended claims.

1. An alignment guide for assembling pipette tip support cards, comprising:
a base configured for nested insertion into a pipette tip support card;
a plurality of dome-shaped or sloped projections protruding from the base, each projection having a sloped surface configured to contact and to direct a distal end of a pipette tip; and
a plurality of voids interspersed among the plurality of dome-shaped or sloped projections in the base, each void comprising a through-opening in the base sized and configured to receive a distal end of a pipette tip and aligned with a receiver slot on the support card receiver the base is nested therein;
wherein the sloped surfaces are configured to cam a distal end of a pipette tip into a corresponding void during an insertion process so that the voids and projections cooperate to guide pipette tip distal ends into the receiver slots by laterally redirecting contacted distal ends toward aligned voids and into the receiver slots without contact between adjacent tips.

2. The alignment guide of claim 1, wherein the base is removable from the support card.

3. The alignment guide of claim 1, wherein the dome-shaped projections have a radius in the range of 0.5-5 mm.

4. The alignment guide of claim 1, wherein the projections are dome-shaped, hemispherical, conical, or frustoconical.

5. The alignment guide of claim 1, wherein each void is coaxial with a corresponding receiver slot within ±1.0 mm.

6. The alignment guide of claim 1, wherein the receiver slots include chamfered or funnel-shaped lead-ins.

7. The alignment guide of claim 1, wherein a clearance between a distal tip diameter and a corresponding void is between 0.1 mm and 1.0 mm.

8. The alignment guide of claim 1, wherein the projections have a height in the range of 2-20 mm.

9. A pipette tip support card system, comprising:
a first support card having a plurality of pipette tip support holes and receiver slots;
a second support card having a plurality of pipette tip support holes and receiver slots; and
the alignment guide comprising:
a base configured for nested insertion into the second pipette tip support card;
a plurality of dome-shaped or sloped projections protruding from the base, each projection having a sloped surface configured to contact and to direct a distal end of a pipette tip; and
a plurality of voids interspersed among the plurality of dome-shaped or sloped projections in the base, each void comprising a through-opening in the base sized and configured to receive a distal end of a pipette tip and aligned with a receiver slot on the second support card when the base is nested therein;
wherein the sloped surfaces are configured to cam a distal end of a pipette tip into a corresponding void during an insertion process so that the voids and projections cooperate to guide pipette tip distal ends into the receiver slots by laterally redirecting contacted distal ends toward aligned voids and into the receiver slots without contact between adjacent tips.

10. The system of claim 9, wherein a pitch of the tip support holes and the receiver slots is about 18 mm, 9.0 mm, 4.5 mm, or 2.25 mm.

11. The system of claim 9, wherein the alignment guide is removably coupled to the second support card by snap features, rails, or detents.

12. The system of claim 9, wherein the second support card includes antistatic material or conductive pathways to dissipate charge from captured distal ends.

13. The system of claim 9, wherein the support cards and the alignment guide are injection molded from polypropylene, polyethylene, ABS, or combinations thereof.

14. A pipette tip rack comprising:
a support card having an array of tip support holes and receiver slots; and
an integrated alignment structure disposed below the support card and comprising a two-dimensional array of projections narrowing towards an apex to form intervening voids aligned with receiver slots on the support card, the projections including sloped camming surfaces positioned to laterally redirect distal ends toward the intervening voids and into the receiver slots during insertion; wherein the integrated alignment structure supports and constrains distal ends of tips seated in the receiver slots to maintain a true plumb orientation.

15. The pipette tip rack of claim 14, wherein the integrated alignment structure is monolithic with the support card.

16. The pipette tip rack of claim 14, wherein the integrated alignment structure reduces tip-to-tip lateral contact relative to an otherwise identical rack lacking the integrated alignment structure.

17. A method of assembling a pipette tip support card bundle, comprising:
providing a first support card and a second support card, each having pipette tip support holes and receiver slots;
inserting an alignment guide into the second support card, the guide having dome-shaped or sloped projections and voids aligned with the receiver slots;
inserting a first plurality of pipette tips into the support holes of the first support card, wherein distal ends of the first plurality are guided by the dome-shaped projections into the receiver slots of the second support card;
removing the alignment guide; and
inserting a second plurality of pipette tips into the support holes of the second support card, wherein distal ends of the second plurality are guided by the first plurality into the receiver slots of the first support card.

18. The method of claim 17, wherein the inserting steps are performed automatically using a robotic system.

19. The method of claim 17, wherein the alignment guide prevents static electricity buildup by avoiding tip-to-tip contact.

20. The method of claim 17, further comprising stacking additional support cards to form a multi-layer interleaved bundle.

21. The method of claim 17, further comprising rotating or inverting the partially assembled bundle between inserting the first plurality of pipette tips and the second plurality of pipette tips.

22. The method of claim 17, wherein the receiver slots and tip support holes conform to a 24-format pitch, a 96-format pitch, a 384-format pitch, or a 1536-format pitch.

23. The method of claim 17, wherein the alignment guide is keyed to the second support card to enforce a single orientation.

24. The method of claim 17, further comprising applying an antistatic coating to at least one of the support cards or to the alignment guide.

25. The method of claim 17, wherein the dome-shaped projections have a radius in the range of 0.5-5 mm.

26. The method of claim 17, wherein the projections are dome-shaped, hemispherical, conical, or frustoconical.

27. The method of claim 17, wherein each void is coaxial with a corresponding receiver slot within ±1.0 mm.
